(19) United States
(12) Patent Application Publication
(10) Pub. No.: US 2024/0061189 A1
(43) Pub. Date: Feb. 22, 2024

(54) FLEXIBLE HINGE ALIGNMENT MECHANISMS OF HIGH-POWER OPTICAL SYSTEMS

(71) Applicant: NATIONAL CHUNG SHAN INSTITUTE OF SCIENCE AND TECHNOLOGY, Taoyuan City (TW)

(72) Inventors: CHIANG-HSIN LIN, Taoyuan City (TW); JIAN-HUNG LIN, Taoyuan City (TW); PO-TSE TAI, Taoyuan City (TW); TSONG-DONG WANG, Taoyuan City (TW); BO-KAI FENG, Taoyuan City (TW)

(21) Appl. No.: 17/891,155

(22) Filed: Aug. 19, 2022

(51) Int. Cl. G02B 6/38; G02B 6/36

(52) U.S. Cl. CPC G02B 6/3888; G02B 6/3628; G02B 6/3858

(57) ABSTRACT

A flexible hinge alignment mechanism of a high-power optical system is made of a flexible hinge, and may lead to a relatively weak region of the hinge to achieve elastic displacement or rotation under stress loading. Through movable actuators such as screws and springs, the area is precisely moved, and the function of accurate alignment is achieved. When the flexible hinge causes the structure to move relatively due to the applied forces, it must be ensured that the corresponding distribution of maximum stress needs to be below the yielding point of the material, thus ensuring the mechanism acts in a material's elastic region. The design is beneficial to optimize the design of the optical alignment mechanism.

### BACKGROUND OF THE INVENTION

### 1. Field of the Invention

The present disclosure relates to a flexible hinge alignment mechanism, and in particular to a flexible hinge alignment mechanism of a high-power optical system.

### 2. Description of the Related Art

A complex optical system involves the combination of multiple optical elements, which are mounted on a mechanism to form an opto-mechanical system, and is a common way to compose alignment and a system. When considering the use of special optical systems (such as aerospace applications) or multiple functions (such as ultrafast laser systems or external cavity semiconductor laser systems), their opto-mechanical systems must provide high accuracy and stability. Because the tolerance of mechanical elements exist between manufacture and assembly, optical systems must carry out procedures for alignment, so that the position or angle of optical components reaches the operating conditions as optical design, and thus the system can achieve specific optimal functions and electro-optical conversion efficiencies. In opto-mechanical systems, a common method is to mount optical elements of the system on alignment mechanisms. These mechanisms are allowed to have a larger adjustment allowance to provide the adequate degree of freedom required for alignment. However, the introduction of optical mechanisms increases the complexity of the system, and optical mechanisms that are not properly designed may not be able to provide sufficient precision or stability.

A traditional flexible adjustment precision clamping tool applying to a four-spindle lathe optimizes the rotational machining accuracy of a traditional four-spindle lathe by a flexible hinge structure. The clamping tool is designed with a three-axis rotational degree of freedom and the accuracy can be adjusted to sub-micron levels. In accordance with the needs of actual usage in lathes, the clamping tool increases the degree of freedom on a height axis. The movable adjustment mechanisms are micrometer adjusters composed of manual or piezoelectric materials, but the design of the clamping tool has a backup plate area that avoids excessive deformation of the structure, resulting in increased complexity of manufacturing, and the assembly and process are relatively complicated.

A traditional adjustable laser system uses a single adjustable hinge as an adjustment mechanism. After the manufacture of the rotation shaft position of the hinge is completed, the rotation pivot of the internal grating element thereof is fixed accordingly, but the flexible hinge structure is not designed to avoid excessive structural deformation, and a single actuator alone cannot reach the rotation dimension in two directions. In addition, after adjusting to the optimal position, there is no design to use locking mechanisms to fix the position.

A traditional laser module has a platform to act as a supporting part of the optical fiber within the cantilever. The cantilever must be long enough to provide collimation between the internal laser element and the fiber. The adjustable dimensions of the structure may be X-axis, Y-axis, or X-Y two-axis. The exterior of the alignment platform is covered with a shell to avoid interference with external environmental factors during the alignment process. The position of the fiber will be adjusted during the alignment process, and the coupling efficiency of the laser energy to the internal fiber will be monitored in real time. Due to the change of the internal fiber position by changing the length of the cantilever itself protruding out of the package, the method is only suitable for small volume and small power output. In addition, the prior art do not disclose that it has an appropriate fixing mechanism, it is expected that the system is prone to have problems with poor stability.

A traditional flexible hinge phase deviation adapter applying to the FIZEAU interferometer adopts an adapter with a monolithic body design for mounting on the interferometer to provide a phase deviation of a reference light or the output light itself. The adapter contains two parts: the first part is a fixed part, which is used to lock and fix with the interferometer; the second part is a movable part to allow a beam to pass through. The adapter, combined with a flexible hinge, can be applied to the adjustment of the axial position. The system can be added with an actuator to provide automated axial position adjustment. The accurate axial position adjustment is achieved in a small volume to cause that the adjustable allowance is not over the requirements. In addition, high-precision tools are required for the production because of the small volume, which raises the required threshold for production. It should also be noted that if the wall thickness of the adapter adjustment hinge is too thin, the stress of the locking may cause the flexible hinge to fail.

In summary, there is still room for improvement of the alignment mechanism of the high-power optical system, so the application has developed a flexible hinge alignment mechanism of a high-power optical system to effectively solve the problems encountered by the alignment mechanism.

### BRIEF SUMMARY OF THE INVENTION

In view of the shortcomings of the above-mentioned prior art, the main object of the present disclosure is to provide a flexible hinge alignment mechanism of a high-power optical system with high accuracy and stability. Furthermore, it is beneficial to improve the optical properties of the system, such as conversion efficiency. In addition, the design can be highly resistant to the environmental factors (e.g., vibration and temperature changes) and the safety of operators in the alignment process is also taken into account.

To achieve the above object and more, a flexible hinge alignment mechanism of a high-power optical system is proposed by the present disclosure, comprising: an alignment mechanism body, being a single block of elastic material, made of integrated forming; a first hinge, located at a lower position of the alignment mechanism body, having a first notch in a first direction, the first notch is formed by a first upper platform and a first lower platform; a second hinge, located at a higher position of the alignment mechanism body, having a second notch in a second direction, the second notch is formed by a second upper platform and a second lower platform; a first actuator, disposed on the first upper platform of the first notch to make the first upper platform produce a positive or negative angle displacement with respect to the first lower platform; and a second actuator, disposed on the second upper platform of the second notch to make the second upper platform produce a positive or negative angle displacement with respect to the second lower platform.

Preferably, the first hinge and the second hinge respectively form the first notch and the second notch by cutting off the material with a wire cutting method or a conventional machining method.

Preferably, the first actuator may include a screw and a spring, when the screw overcomes the force of the spring and the equilibrium force of the first hinge, and continues to provide an upward external force, the angle of the first upper platform may be adjusted in a positive direction. In contrast, when the force of the spring is greater than the equilibrium force of the first hinge, the angle of the first upper platform is adjusted in a negative direction.

Preferably, the second actuator may include a screw and a spring, when the screw overcomes the force of the spring and the equilibrium force of the second hinge, and continues to provide an upward external force, the angle of the second upper platform may be adjusted in a positive direction. In contrast, when the force of the spring is greater than the equilibrium force of the second hinge, the angle of the second upper platform is adjusted in a negative direction.

Preferably, part of a material of the second upper platform is further removed to shorten a pivot length of the second hinge.

Preferably, the flexible hinge alignment mechanism further comprises a first locking mechanism and a second locking mechanism, respectively disposed on the first hinge and the second hinge, after the first upper platform and the second upper platform are adjusted to fixed positions, the first notch and the second notch are fixed.

Preferably, the first locking mechanism and the second locking mechanism may respectively have a residual gap between a through hole and the mounting screw to avoid displacement ranges of the first upper platform and the second upper platform over its elastic limit.

Preferably, a surface of the alignment mechanism body is treated with an interface high absorption coating, black anodizing, and surface roughening.

Preferably, the flexible hinge alignment mechanism further comprises a cooling mechanism on the alignment mechanism body.

Preferably, the first direction is perpendicular to the second direction.

The above summary and the following detailed description and accompanying drawings are intended to further illustrate the manner, means and effect of the present disclosure for achieving a predetermined object. Other objects and advantages of the present disclosure will be described in subsequent descriptions and drawings.

### BRIEF DESCRIPTION OF THE DRAWINGS

FIG. 1 is a drawing illustrating a flexible hinge alignment mechanism of a high-power optical system of the present disclosure.

FIG. 2 is a drawing illustrating an alignment mechanism body of the flexible hinge alignment mechanism of the high-power optical system of the present disclosure.

FIG. 3 is a side view of the alignment mechanism body of the flexible hinge alignment mechanism of the high-power optical system of the present disclosure.

FIG. 4 shows distribution of displacement field of a mechanism of an un-optimized mechanism (lower image) and the present disclosure (upper image).

### DETAILED DESCRIPTION OF THE INVENTION

The implementation of the present disclosure is described by the specific embodiments as below, those skilled in the art can easily understand the advantage and effect by the content disclosed by the present specification.

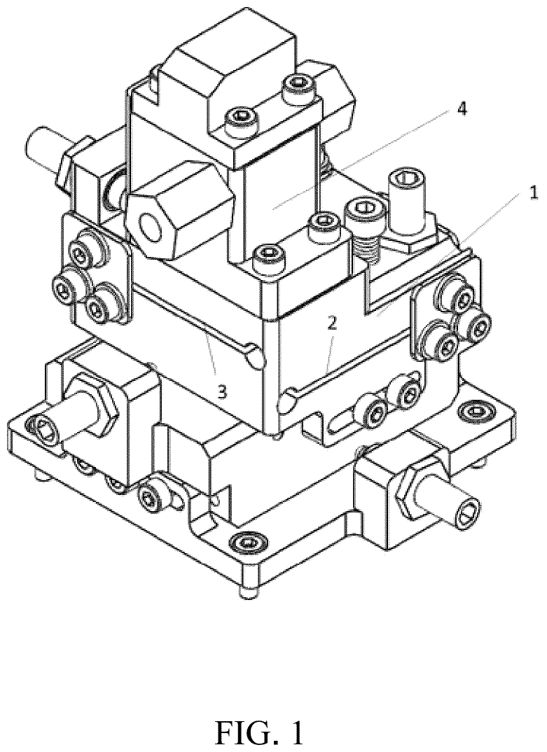

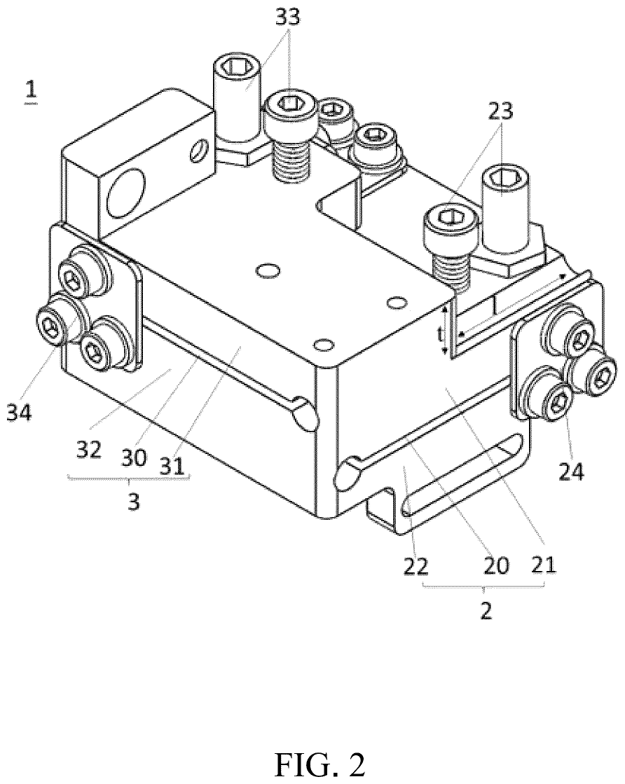

FIG. 1 is a drawing illustrating a flexible hinge alignment mechanism of a high-power optical system of the present disclosure, and FIG. 2 is a drawing illustrating an alignment mechanism body of the flexible hinge alignment mechanism of the high-power optical system of the present disclosure. The present disclosure provides a flexible hinge alignment mechanism of a high-power optical system, comprising: an alignment mechanism body 1, which is a single block of elastic material, made of integrated forming, a single block mechanism is used to achieve multi-dimensional adjustment, in order to reduce the cumulative error problem caused by the combination of multiple components. The alignment mechanism body 1 provides a first hinge 2 and a second hinge 3 thereon, and the flexible hinge design is used as a high accuracy and stability adjustment mechanism for angle (or displacement).

The first hinge 2 which is located at a lower position is provided on the alignment mechanism body 1 (e.g., a height in the Z axis direction), having a first notch 20 in a first direction (e.g., X axis direction), in the present embodiment, the first notch 20 may be formed by cutting off the material using a wire cutting method or a conventional machining method, the first notch 20 is formed by a first upper platform 21 and a first lower platform 22, and a first actuator 23 is disposed on the first upper platform 21 of the first notch 20 to make the first upper platform 21 produce a positive or negative angle displacement with respect to the first lower platform 22.

In the present embodiment, the first actuator 23 may include a screw and a spring, when the screw overcomes the force of the spring and the equilibrium force of the first hinge 2, and continues to provide an upward external force, the angle of the first upper platform 21 may be adjusted in a positive direction. In contrast, when the force of the spring is greater than the equilibrium force of the first hinge 2, the angle of the first upper platform 21 is adjusted in a negative direction.

The second hinge 3 which is located at a higher position is provided on the alignment mechanism body 1 (e.g., a height in the Z axis direction), having a second notch 30 in a second direction (e.g., Y axis direction). In the present embodiment, the second notch 30 may be formed by cutting off the material using a wire cutting method or a conventional machining method. The second notch 30 is formed by a second upper platform 31 and a second lower platform 32, and a second actuator 33 is disposed on the second upper platform 31 of the second notch 30 to make the second upper platform 31 produce a positive or negative angle displacement with respect to the second lower platform 32. The first direction is perpendicular to the second direction.

In the present embodiment, the second actuator 33 may include a screw and a spring, when the screw overcomes the force of the spring and the equilibrium force of the second hinge 3, and continues to provide an upward external force, the angle of the second upper platform 31 may be adjusted in a positive direction. In contrast, when the force of the spring is greater than the equilibrium force of the second hinge 3, the angle of the second upper platform 31 is adjusted in a negative direction.

In more detail, the optimized flexible hinge structure of the notch or upper platform can be deformed when the external force is applied, leading to a relative movement between adjacent rigid materials. A notch is usually formed by cutting off the material on a rectangular section or circular section beam with wire cutting technology, and a relatively weak position of the material is used to achieve rotation or displacement adjustment. The adjustment dimensions and accuracy of the alignment mechanism depends on the requirements of the mounted optical elements in the optical system. In addition, the system uses a high-precision actuator as an adjustment mechanism, which will improve the accuracy of the adjustment. Taking the rotation adjustment of the alignment mechanism with the flexible hinge into account, whether the angle adjustment in the positive or negative direction is considered, an external force greater than the equilibrium force of the flexible hinge itself must be applied. The external forces originated from screws and springs are considered here, and the spring will be inserted with a screw to control the spring force. When the screw overcomes the force of the spring and the equilibrium force of the flexible hinge, and continues to provide an upward external force, the angle of the upper platform may be adjusted in a positive direction. In contrast, when the spring force which is provided in an opposite direction is greater than the equilibrium force of the flexible hinge, the angle of the upper platform is adjusted in a negative direction. The above method is only part of the flexible hinge adjustment and is not limited thereto.

In addition, the operation of high-power optical systems is often accompanied by a large amount of waste heat, and it might lead to the failure of the system due to the damage of the optical elements. The waste heat needs to be dissipated out of the system by the design of air-cooled or even water-cooled according to the heat density and heat dissipation area and other parameters, in order to ensure the stability of the system. In the embodiment, a cooling mechanism 4 may be provided on the alignment mechanism body 1. In addition, considering the stray light generated during the operation of the system, the alignment mechanism in the system can be treated to black anodizing (e.g., a surface of the alignment mechanism body 1 is treated with a high absorption coating, black anodizing and surface roughening). Additional devices such as light-absorbing elements can be mounted in the appropriate positions. The optical system is turned on at full or adequate power, and the alignment mechanism is applied to change the angle or position of the optical element, and the relevant optical output parameters monitored will change accordingly. The above goes with a proper alignment process to make the optical output properties of the system meet the requirements finally, and the position of the flexible hinge is fixed accordingly.

In the present embodiment, the positions of the first hinge 2 and the second hinge 3 are fixed by a first locking mechanism 24 and a second locking mechanism 34, thus increasing the stability of the optical system. Each of the first locking mechanism 24 and the second locking mechanism 34 is a sheet made of a similar alignment mechanism body. Additionally, there are suitable through holes on which fixing screws pass through. Residual gaps of the screws and the through holes on each of the first locking mechanism 24 and the second locking mechanism 34 can be used as an angle (or a displacement) constraint of each of the first hinge 2 and the second hinge 3, in order to ensure that the designed mechanism acts in the material's elastic region. In more detail, the first locking mechanism 24 and the second locking mechanism 34 are respectively disposed on the first hinge 2 and the second hinge 3, after the first upper platform 21 and the second upper platform 31 are adjusted to fixed positions, the first notch 20 and the second notch 30 are fixed. The first locking mechanism 24 and the second locking mechanism 34 may respectively have a through hole residual gap 240 to avoid displacement ranges of the first upper platform 21 and the second upper platform 31 over an elastic limit. The flexible hinge alignment mechanism of the high-power optical system uses the first locking mechanism 24 and the second locking mechanism 34 to limit during the adjustment process; after positioning, the first locking mechanism 24 and the second locking mechanism 34 are used to fix the alignment mechanism body 1 on the long-term, helping to improve its stability.

The present disclosure uses the finite element method with the structural mechanics module to carry out analysis of its mechanical properties made by the flexible hinge method. The displacement field and stress distribution of the structure are quantitatively analyzed with the actually manufactured material and geometric characteristics along with the force applying position and value of the alignment mechanism. While considering the dynamic process of a flexible hinge, the most common type of failure is plastic deformation. This is due to the fact that the flexible hinge must be within the elastic limit of the material in order to provide a resilience during the adjustment process. Conversely, if the stress value of the flexible hinge is higher than the yield strength of the material, it can be expected that the structure will fail because of plastic deformation damage (including the loss of linear relationship between stress and strain), and the structure will lose the original elasticity and adjustability. It is worth noting that while planning the alignment mechanism by applying the flexible hinge concept, the designer had better calculate the distribution of stress field through designed flexible hinge mechanism by numerical analysis to ensure that the corresponding stress value of the adjustment process is less than the yield strength, and confirm that the degree of angle or displacement adjustment meets the alignment requirements. Considering that the manufactured material needs to be easily machined, the designed mechanism is made of AL7075 material, the corresponding elastic modulus of the material is 71.7 GPa, the yield strength is 503 MPa. Simulation results suggest the maximum allowable displacement of the flexible hinge alignment mechanism in the elastic region is about 1.5 mm both in the positive and negative adjustments.

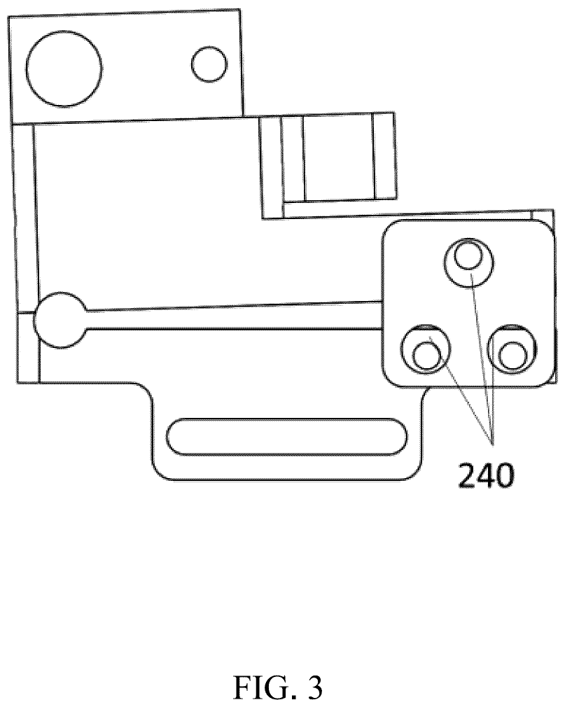

In the present embodiment, the optimization design of the mechanism is carried out by the analysis results: each of the first notch 20 and the second notch 30 has a hollow gap with a width of 1.5 mm, as an adjustment limit to constrain the downward angle. In contrast, the upward adjustment limit is constrained by the through hole residual gap 240 of the locking mechanism. In addition, the precise calculation of the displacement field distribution would be helpful when designing the locking mechanism to lock the optimal alignment position or angle with screws and washers. In order to achieve the functionality of the locking mechanism, it is required for the user to put the locking mechanism against the designed position with screws and washers in the alignment process, but it is not yet able to lock tightly to provide the required degree of freedom for the alignment process. The adjustment limit constraint of the locking mechanism is shown in FIG. 3. Suppose that the hinge is adjusted toward a positive angle to a position of the maximum allowable angle, which is exactly close to the maximum displacement allowed by the screw residual gap above the locking mechanism, as a constraint in the positive direction (the screw and washer are omitted herein to show the relative position).

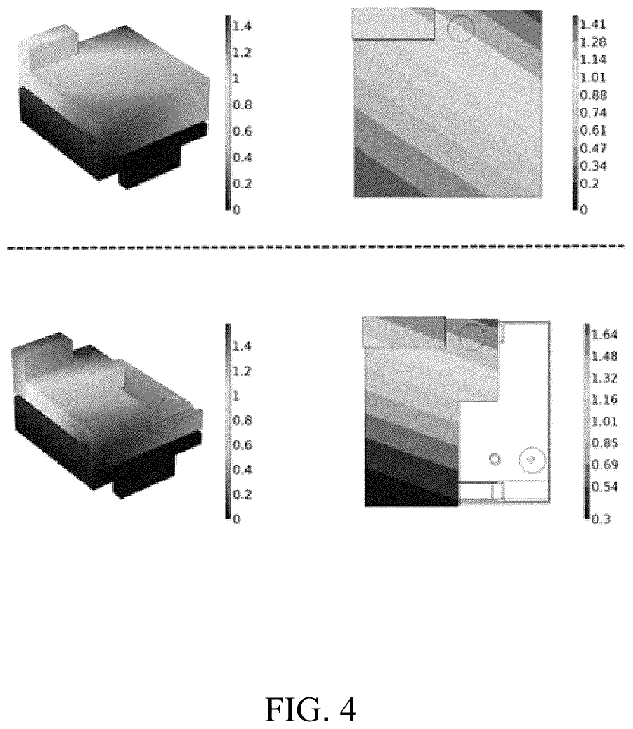

FIG. 4 shows distribution of displacement field of a mechanism of an un-optimized mechanism (lower image) and the present disclosure (upper image). Through optimizing the geometric structure of the flexible hinge alignment mechanism it can help to increase the adjustment allowance or reduce the force effect of the mounted optical elements. The above-mentioned flexible hinge alignment mechanism has been preliminarily optimized. In the un-optimized flexible hinge alignment mechanism, considering the same boundary condition setting, the corresponding maximum displacement distribution within the maximum elastic limit is simulated, and the calculation result is shown in the upper image of FIG. 4, and the lower image of FIG. 4 is the displacement distribution of the preliminarily optimized hinge alignment mechanism. The results show that when the angle of the un-optimized flexible hinge alignment mechanism is adjusted to the maximum value, because the interaction exists between the two hinges, the lower hinge will also be displaced to a positive angle, and thus the displacement field will be distributed obliquely. In contrast, by removing part of the geometry (removing part of the material of the second upper platform 31, such as removing the material of the structure length l and thickness t), the optimized structure shortens the pivot length of the second hinge 3, compensating for the displacement to approaching the parallel distribution. At the same time, the shorter pivot hinge also represents a larger maximum allowable displacement, which helps to increase the adjustment allowance. To sum up, the optimized structure successfully solves the cross-talk motion problem of the two directional dimensions of a single hinge adjustment, so the angle at which the mechanism can move tends to be independent. When the displacement approaches to the parallel distribution more, it will help to reduce the mechanism bending or the force on the optical elements during the adjustment process, so it is more suitable for applications to the alignment of precision optical systems, such as reducing the smile effect of semiconductor laser diodes, or avoiding the failure of the grating because of the unexpected stress loading.

In summary, the present disclosure is a flexible hinge alignment mechanism of a high-power optical system, the mechanism applying the concept of the design has a high adjustment accuracy and long-term position stability, while having a greater resistance to environmental changes (such as temperature and vibration). Considering the application to high-power optical systems, the surface of the mechanism is treated to black anodizing, and the light absorbing elements can be mounted in the appropriate positions that can effectively reduce the harm of scattered light. If the alignment process must be operated in a high-power output environment, the adjusted interface can be changed to a high-precision automatic adjustment screw or piezoelectric material to avoid the risk that operators contact with the laser during the alignment process. By designing the locking mechanism, the angle or position of the flexible hinge can be fixed for a long time at a position that the alignment is completed. Furthermore, it has the function of limiting the angle and displacement adjustment during the alignment process. The actual design of the flexible hinge alignment mechanism is often limited by the size of the mounted optical elements, the adjustment dimension and the adjustment distance or angle. In addition, there are many factors to be considered in the real application, such as the easy-handling property of movable pieces such as manual adjustment of screws and springs, and the space required to disassemble and mount optical elements, must also be taken into account. The optimization method proposed by the present disclosure may provide a solution to the above problems encountered in the actual design of the flexible hinge alignment mechanism. For example, part of the area is removed to shorten a pivot length of the second hinge 3, the cross-talk motion of the two directional dimensions of a single hinge adjustment is reduced, and it can be used for mounting the actuator of the lower hinge or as an area for mounting the locking mechanism.

The above-described embodiments illustrate the characteristics and effects of the present disclosure only, not to limit the scope of the substantive technical content of the present disclosure. Numerous modifications and variations could be made to the embodiments by those skilled in the art without departing from the scope and spirit of the present disclosure. Therefore, the scope of the disclosure is defined by the claims.

What is claimed is:

1. A flexible hinge alignment mechanism of a high-power optical system, comprising:
an alignment mechanism body, being a single block of elastic material, made of integrated forming;
a first hinge, provided at a first height of the alignment mechanism body, having a first notch in a first direction, the first notch is formed by a first upper platform and a first lower platform;
a second hinge, provided at a second height of the alignment mechanism body, having a second notch in a second direction, the second notch is formed by a second upper platform and a second lower platform;
a first actuator, disposed on the first upper platform of the first notch to make the first upper platform produce a positive or negative angle displacement with respect to the first lower platform; and
a second actuator, disposed on the second upper platform of the second notch to make the second upper platform produce a positive or negative angle displacement with respect to the second lower platform.

2. The flexible hinge alignment mechanism according to claim 1, wherein the first hinge and the second hinge respectively form the first notch and the second notch by cutting off part of the elastic material using a wire cutting method or a conventional machining method.

3. The flexible hinge alignment mechanism according to claim 1, wherein the first actuator includes a screw and a spring, when the screw overcomes the force of the spring and the equilibrium force of the first hinge, and continues to provide an upward external force, the angle of the first upper platform is adjusted in a positive direction; in contrast, when the force of the spring is greater than the equilibrium force of the first hinge, the angle of the first upper platform is adjusted in a negative direction.

4. The flexible hinge alignment mechanism according to claim 1, wherein the second actuator includes a screw and a spring, when the screw overcomes the force of the spring and the equilibrium force of the second hinge, and continues to provide an upward external force, the angle of the second upper platform is adjusted in a positive direction; in contrast, when the force of the spring is greater than the equilibrium force of the second hinge, the angle of the second upper platform is adjusted in a negative direction.

5. The flexible hinge alignment mechanism according to claim 1, wherein part of a material of the second upper platform is further removed to shorten a pivot length of the second hinge.

6. The flexible hinge alignment mechanism according to claim 1, further comprising a first locking mechanism and a second locking mechanism, respectively disposed on the first hinge and the second hinge, after the first upper platform and the second upper platform are adjusted to fixed positions, the first notch and the second notch are fixed.

7. The flexible hinge alignment mechanism according to claim 6, wherein the first locking mechanism and the second locking mechanism respectively have a through hole residual gap to avoid displacement ranges of the first upper platform and the second upper platform exceeding an elastic limit.

8. The flexible hinge alignment mechanism according to claim 1, wherein a surface of the alignment mechanism body is treated with a high absorption coating, black anodizing and surface roughening.

9. The flexible hinge alignment mechanism according to claim 8, further comprising a cooling mechanism, provided on the alignment mechanism body.

10. The flexible hinge alignment mechanism according to claim 1, wherein the first direction is perpendicular to the second direction.
